(19) United States
(12) Patent Application Publication
(10) Pub. No.: US 2019/0073871 A1
(43) Pub. Date: Mar. 7, 2019

(54) Object Allocation Method and Apparatus

(71) Applicant: Alibaba Group Holding Limited, Grand Cayman (KY)

(72) Inventors: Hong Zhu, Zhejiang (CN); Jie Du, Zhejiang (CN); Bing Hu, Zhejiang (CN)

(73) Assignee: Alibaba Group Holding Limited

(21) Appl. No.: 16/179,721

(22) Filed: Nov. 2, 2018

Related U.S. Application Data
(63) Continuation of application No. PCT/CN2017/079861, filed on Apr. 10, 2017.

(30) Foreign Application Priority Data
May 4, 2016 (CN) 201610289713.3

(51) Int. Cl. G07F 17/32; G01H 3/12

(52) U.S. Cl. CPC G07F 17/3244; G06F 17/30743; G01H 3/12; G07F 17/3269

(57) ABSTRACT

Object allocation methods and apparatuses are provided. A method may include starting a playback of a predetermined audio file according to a received allocation start command; determining allocation time intervals corresponding to the predetermined audio file, and a number of allocations corresponding to each allocation time interval, wherein the number of allocations is related to a predetermined acoustic feature parameter of the predetermined audio file in the respective allocation time interval; and obtaining and allocating the number of allocations of objects to allocable users corresponding to the respective allocation time interval. A process of allocation of objects can be optimized using the technical solutions of the present disclosure.

### CROSS REFERENCE TO RELATED PATENT APPLICATIONS

This application claims priority to and is a continuation of PCT Patent Application No. PCT/CN2017/079861 filed on 10 Apr. 2017 and is related to and claims priority to Chinese Patent Application No. 201610289713.3, filed on 4 May 2016, entitled “Object Allocation Method and Apparatus,” which are hereby incorporated by reference in their entirety.

### TECHNICAL FIELD

The present disclosure relates to the technical field of service processing, and particularly to object allocation methods and apparatuses.

### BACKGROUND

Along with the development of network technologies, a variety of service implementation methods have emerged. An interaction of virtual items in a form of “lottery” is taken as an example. Gift money, vouchers, redemption vouchers, etc. can be distributed to some of the users of all users by means of a lottery.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of the above, the present disclosure provides an object allocation method and apparatus, which can optimize a process of allocating an object.

To achieve the above objectives, the present disclosure provides the following technical solutions.

In implementations, an object allocation method is provided, which includes starting a playback of a predetermined audio file according to a received allocation start command; determining allocation time intervals corresponding to the predetermined audio file, and a number of allocations corresponding to each allocation time interval, wherein the number of allocations is related to a predetermined acoustic feature parameter of the predetermined audio file in the respective allocation time interval; and obtaining and allocating the number of allocations of objects to allocable users corresponding to the respective allocation time interval.

In implementations, an object allocation apparatus is provided, which includes a starting unit configured to start a playback of a predetermined audio file according to a received allocation start command; a determination unit configured to determine allocation time intervals corresponding to the predetermined audio file, and a number of allocations corresponding to each allocation time interval, wherein the number of allocations is related to a predetermined acoustic feature parameter of the predetermined audio file in the respective allocation time interval; and an allocation unit configured to obtain and allocate the number of allocations of objects to allocable users corresponding to the respective allocation time interval.

In implementations, an object allocation method is provided, which includes obtaining a real-time playback status of a predetermined audio file; determining probability description information of a current user being successfully allocated with a predetermined object according to the real-time playing status, and displaying the probability description information; and initiating an allocation request corresponding to the current user to a server, and receiving and displaying an allocation result returned by the server.

In implementations, an object allocation apparatus is provided, which includes an acquisition unit configured to obtain a real-time playback status of a predetermined audio file; a probability display unit configured to determine probability description information of a current user being successfully allocated with a predetermined object according to the real-time playing status, and display the probability description information; and a result display unit configured to initiate an allocation request corresponding to the current user to a server, and receive and display an allocation result returned by the server.

In implementations, a configuration method for an object allocation rule is provided, which includes obtaining a predetermined audio file for object allocation; separately extracting predetermined acoustic feature parameters of the predetermined audio file in each allocation time interval according to allocation time intervals corresponding to the predetermined audio file; and configuring a number of allocations corresponding to the respective allocation time interval according to the predetermined acoustic feature parameters, wherein a corresponding number of allocations of objects are allocated to allocable users corresponding to an arbitrary one of the allocation time intervals when the predetermined audio file is played in the arbitrary one of the allocation time intervals.

In implementations, a configuration apparatus for an object allocation rule is provided, which includes an acquisition unit configured to obtain a predetermined audio file for object allocation; an extraction unit configured to separately extract predetermined acoustic feature parameters of the predetermined audio file in each allocation time interval according to allocation time intervals corresponding to the predetermined audio file; and a configuration unit configured to set a number of allocations corresponding to the respective allocation time interval according to the predetermined acoustic feature parameters, wherein a corresponding number of allocations of objects are allocated to allocable users corresponding to an arbitrary one of the allocation time intervals when the predetermined audio file is played in the arbitrary one of the allocation time intervals.

As can be seen from the above technical solutions, the present disclosure can realize allocation of objects when users listen to an audio file by combining an object allocation operation with acoustic features of the audio file, thereby realizing interactions between the object allocation operation and the acoustic features of the audio file, and helping to improve interestingness in a process of object allocation.

### BRIEF DESCRIPTION OF THE DRAWINGS

FIG. 1A is a flowchart of a method for configuring an object allocation rule according to an exemplary embodiment of the present disclosure.

FIG. 1B is a flowchart of a server-side object allocation method according to an exemplary embodiment of the present disclosure.

FIG. 2 is a schematic diagram of processing stages of an object allocation according to an exemplary embodiment of the present disclosure.

FIG. 3 is a flowchart of a pre-processing stage of the embodiment shown in FIG. 2.

FIG. 4 is a schematic diagram showing a waveform distribution of an audio file according to an exemplary embodiment of the present disclosure.

FIG. 5 is a schematic diagram of a distribution of allocation objects according to an exemplary embodiment of the present disclosure.

FIG. 6 is a flowchart of an object allocation stage of the embodiment shown in FIG. 2.

FIG. 7 is a schematic structural diagram of an electronic device according to an exemplary embodiment of the present disclosure.

FIG. 8 is a block diagram of a server-side object allocation apparatus according to an exemplary embodiment of the present disclosure.

FIG. 9 is a flowchart of a client-side object allocation method according to an exemplary embodiment of the present disclosure.

FIG. 10 is a diagram of a system architecture for implementing an object allocation function according to an exemplary embodiment of the present disclosure.

FIG. 11 is a diagram of another system architecture for implementing an object allocation function according to an exemplary embodiment of the present disclosure.

FIG. 12 is a schematic structural diagram of an electronic device according to an exemplary embodiment of the present disclosure.

FIG. 13 is a block diagram of a client-side object distribution apparatus according to an exemplary embodiment of the present disclosure.

FIG. 14 is a schematic structural diagram of an electronic device according to an exemplary embodiment of the present disclosure.

FIG. 15 is a block diagram of an apparatus for configuring an object allocation rule according to an exemplary embodiment of the present disclosure.

### DETAILED DESCRIPTION

In order to further describe the present disclosure, the following examples are provided.

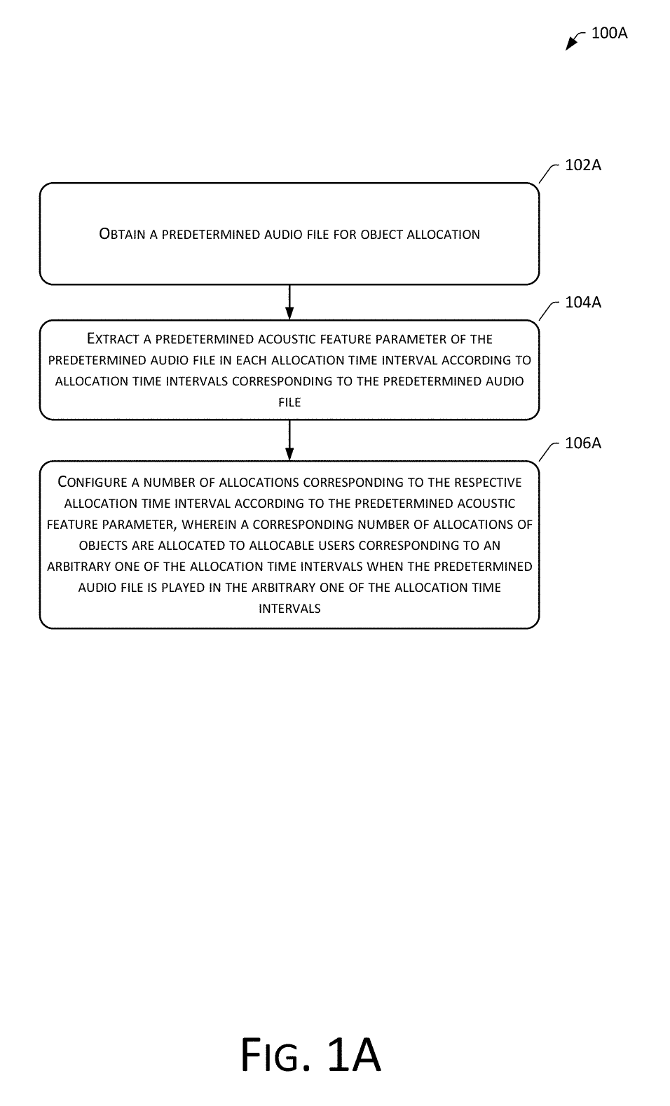

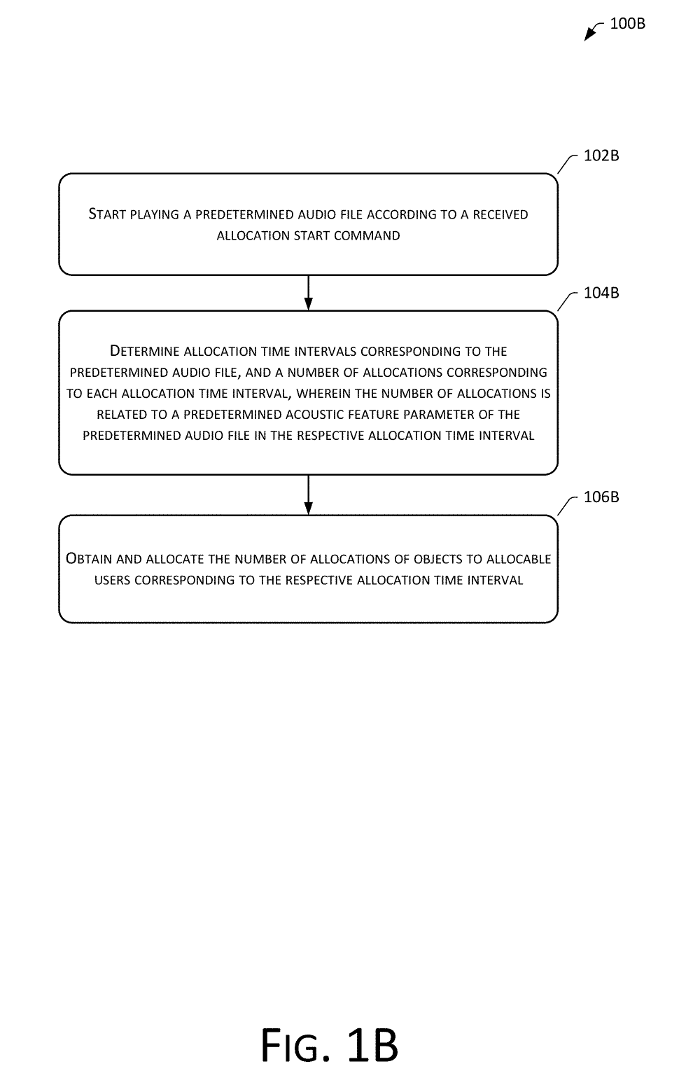

FIG. 1A is a flowchart of a method 100A for configuring an object allocation rule according to an exemplary embodiment of the present disclosure. As shown in FIG. 1A, the method 100A is applied to a server, and may include the following operations:

Operation 102A: Obtain a predetermined audio file for object allocation.

Operation 104A: Extract a predetermined acoustic feature parameter of the predetermined audio file in each allocation time interval according to allocation time intervals corresponding to the predetermined audio file.

In implementations, the allocation time intervals may be a plurality of intervals that are obtained by dividing a playback sequence of the predetermined audio file according to a predetermined time length. The predetermined acoustic feature parameter may include at least one of the following: a frequency of vibration and an amplitude of vibration.

Operation 106A: Configure a number of allocations corresponding to the respective allocation time interval according to the predetermined acoustic feature parameter, wherein a corresponding number of allocations of objects are allocated to allocable users corresponding to an arbitrary one of the allocation time intervals when the predetermined audio file is played in the arbitrary one of the allocation time intervals.

In implementations, first audio sampling point(s) may be determined from a plurality of audio sampling points in each allocation time interval of the predetermined audio file. Value(s) of predetermined acoustic feature parameter(s) of the first audio sampling point(s) satisf(ies) a predetermined numerical criterion. A corresponding number of allocations is configured according to a number of the first audio sampling point(s) or a sum of the value(s) of the predetermined acoustic feature parameter(s) of all the first audio sampling point(s) in each allocation time interval. For example, a number of allocations may be positively related to a number of first audio sampling point(s) or a sum of value(s) of predetermined acoustic feature parameter(s) of all of the first audio sampling point(s) within a corresponding allocation time interval. A predetermined numerical criterion includes, for example, being not less than a predetermined value.

Correspondingly, FIG. 1B is a flowchart of an object allocation method 100B according to an exemplary embodiment of the present disclosure. As shown in FIG. 1B, the method 100B is applied to a server, and may include the following operations:

Operation 102B: Start playing a predetermined audio file according to a received allocation start command.

In implementations, the allocation start command may be directly sent to the server by a staff member. Alternatively, the allocation start command may also be sent by any predefined user. The present disclosure does not have any limitation thereon.

In implementations, the predetermined audio file may be any audio file selected in advance. The number of predetermined audio files may be one or more.

Operation 104B: Determine allocation time intervals corresponding to the predetermined audio file, and a number of allocations corresponding to each allocation time interval, wherein the number of allocations is related to a predetermined acoustic feature parameter of the predetermined audio file in the respective allocation time interval.

In implementations, each predetermined audio file may include at least one allocation time interval, and according to differences in predetermined acoustic feature parameters among each allocation time interval, each allocation time interval may have a corresponding number of allocations. This thereby enables a process of allocating objects to mutually match and echo with a process of playing a predetermined audio file, thereby improving the interestingness in the process.

In implementations, the predetermined acoustic feature parameter may include at least one of a frequency of vibration and an amplitude of vibration.

In implementations, the predetermined audio file has a plurality of audio sampling points in each allocation time interval, and a number of allocations may be the same as the number of first audio sampling points or the sum of values of acoustic wave feature parameters of all the first audio sampling points in a corresponding allocation time interval. For example, a number of allocations may be positively related to the number of first audio sampling points or the sum of the values of the predetermined acoustic feature parameters of all of the first audio sampling points within the corresponding allocation time interval. A value of a predetermined acoustic feature parameter of an audio sampling point satisfies a predetermined numerical criterion, such as being not less than a predetermined value.

Operation 106B: Obtain and allocate the number of allocations of objects to allocable users corresponding to the respective allocation time interval.

In implementations, an object may be a virtual item such as gift money, a voucher, a redemption voucher, or the like, or may be any physical item. The server may allocate ID information corresponding to a physical item, and then distribute the corresponding physical item to a user according to a distribution result.

In implementations, an allocation request sent by a user through an electronic device may be received. When any allocation request from any user is received in any of the allocation time intervals, the any user may be treated as an allocable user corresponding to the any allocation time interval. In implementations, by receiving the allocation request issued by the user, the user's allocation demand can be accurately identified, thereby allocating an object to the user who has the allocation demand.

The number of allocation requests sent by each allocable user in a corresponding allocation time interval may also be counted, and the probability that each allocable user is allocated with an object is positively correlated with a corresponding counted value. In implementations, by positively correlating the probability of allocating an object with the number of allocation requests that are sent, a user is caused to perform operations of sending an allocation request even more, with a goal of increasing the probability that he/she will be allocated with an object, thereby helping a smooth execution and effective promotion of activities of the entire allocation of objects.

In implementations, when receiving an allocation request from any user, a group to which the any user belongs is determined. When the group is a predefined association group corresponding to any one of the allocation time intervals, such any user is set as an allocable user corresponding to the any one of the allocation time intervals. In implementations, by configuring a corresponding predefined association group for an allocation time interval, users of different groups can be differentiated to satisfy reward and punishment or promotion effects for different groups.

Objects corresponding to any of the foregoing allocation time intervals may be allocated to corresponding allocable users according to a predefined allocation probability corresponding to each predefined association group. In implementations, the probability of allocating an object is a predefined allocation probability, and this probability is related to a group to which the user belongs. As such, users of different groups can be differentiated to satisfy effects of reward and punishment or promotion for different groups.

As can be seen from the above technical solutions, the present disclosure can realize allocation of objects when users listen to an audio file by combining an object allocation operation with acoustic features of the audio file, thereby realizing interactions between the object allocation operation and the acoustic features of the audio file, and helping to improve interestingness in a process of object allocation.

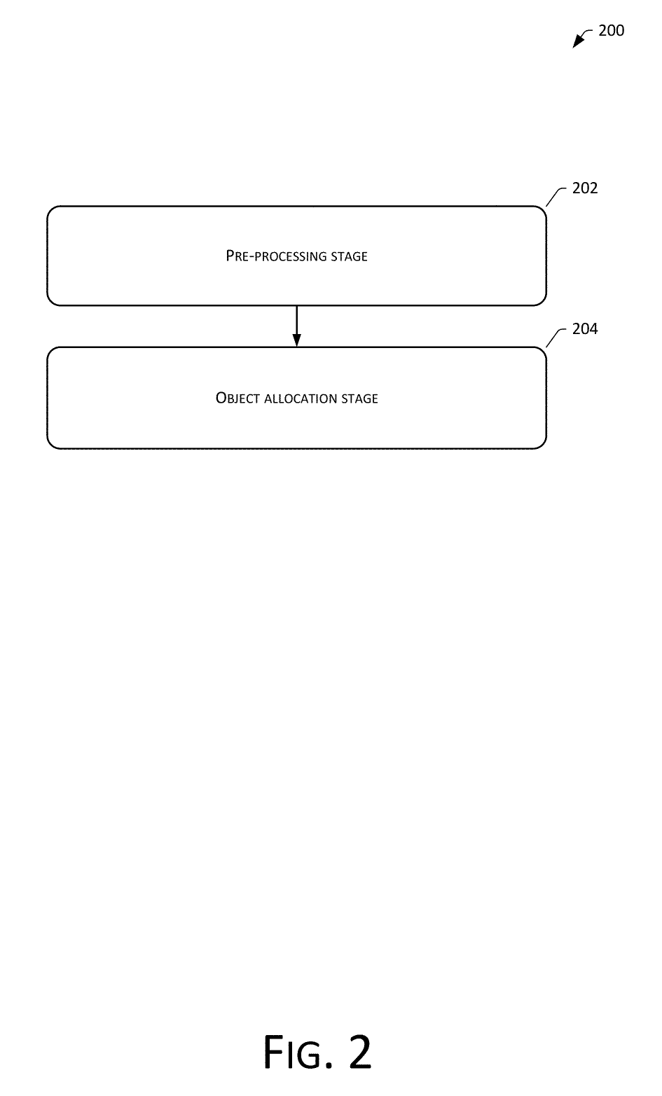

FIG. 2 is a schematic diagram of processing stages of object allocation 200 according to an exemplary embodiment of the present disclosure. As shown in FIG. 2, when an operation of allocating an object is implemented using the technical solutions of the present disclosure, the following two processing stages exist:

Operation 202: Pre-processing stage.

Operation 204: Object allocation stage.

In order to facilitate the understanding, the above two stages are described in detail hereinafter using an audio file in a form of “music” and a process of object allocation in a form of “lottery”.

1. Pre-Processing Stage 300

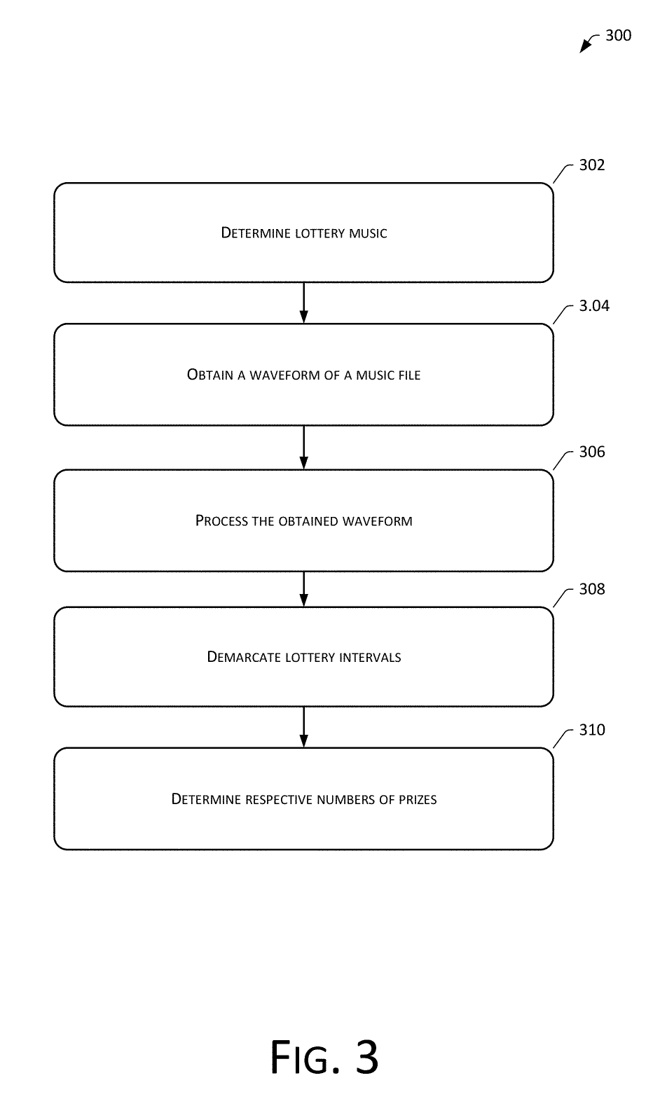

As shown in FIG. 3, the preprocessing stage 300 may include the following operations.

Operation 302: Determine lottery music.

In implementations, the lottery music is equivalent to the “predetermined audio file” in the embodiments shown in FIGS. 1A-1B.

In implementations, the lottery music may be any audio file that is selected, such as a song, an accompaniment, or the like. In the same lottery activity, one or more lottery music may be selected, and each piece of lottery music is processed in the same manner. Specifically, a process described in the following can be applied to each of the selected lottery music.

Operation 304: Obtain a waveform of a music file.

Operation 306: Process the obtained waveform.

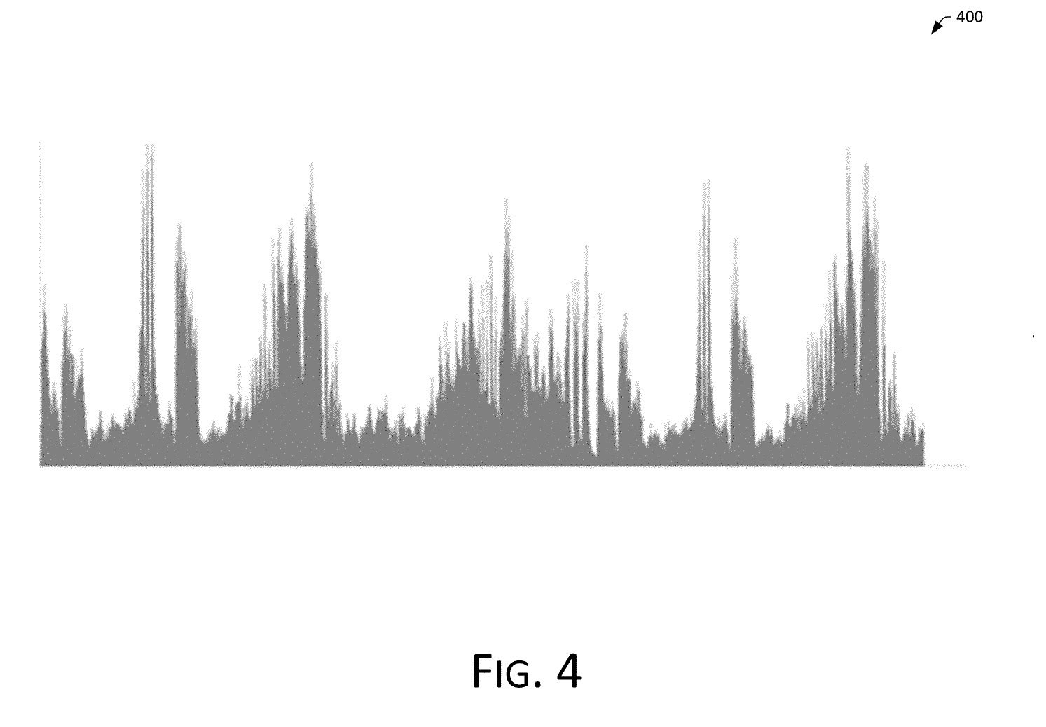

In implementations, the waveform of the music file is a representation of audio data thereof to show continuous variations of the music file over time. In order to facilitate implementation of subsequent operations, the waveform may be subjected to processing such as filtering peaks, troughs, and normalization (the process may use an audio processing method commonly used in related technologies, and details thereof are not redundantly described herein). As such, a waveform 400 as shown in FIG. 4, for example, is obtained.

Operation 308: Demarcate lottery intervals.

In implementations, the lottery intervals correspond to the “allocation time intervals” in the embodiments as shown in FIGS. 1A-1B. Each allocation time interval is used for allocation of at least a portion of objects, i.e., each lottery interval is used for issuing at least a portion of prizes.

In implementations, the allocation time intervals may be a plurality of intervals obtained by dividing a playback sequence of a predetermined audio file according to a predetermined time length. For example, if a duration of playback of a music file is 3 minutes and 12 seconds and the predetermined time length is 10 seconds, the music file can then be demarcated into 19 lottery intervals having a length of 10 seconds and 1 lottery interval having a length of 2 seconds (first 19 lottery intervals correspond to 3 minutes and 10 seconds, and 2 seconds that remain at the end constitute an independent lottery interval).

Operation 310: Determine respective numbers of prizes.

In implementations, the respective numbers of prizes corresponds to the numbers of allocations in the embodiments shown in FIGS. 1A-1B, i.e., numbers of objects available for allocation in respective allocation time intervals from among all objects.

In implementations, the predetermined audio file has a plurality of audio sampling points in each allocation time interval, and audio data corresponding to all the audio sampling points constitutes the predetermined audio file. Each audio sampling point has a corresponding predetermined acoustic feature parameter, such as a vibration frequency, a vibration amplitude, etc. Each audio sampling point can then be classified according to a satisfying condition of a respective value of the predetermined acoustic wave feature parameter with respect to a predetermined numerical criterion, for example, setting as first audio sampling points if the predetermined numerical criterion is satisfied, with remaining ones being set as second audio sampling points, etc.

A “vibration amplitude” is taken as an example. A maximum value of each audio sampling point in a waveform of a music file is assumed to be normalized to 100, and a “predetermined value” may be defined as 50 or any other value. When a value of the vibration amplitude is not less than 50, corresponding audio sampling points can be demarcated as first audio sampling points as described above while remaining audio sampling points are ignored.

In implementations, the foregoing number of allocations may be related to the number of first audio sampling points in a corresponding allocation time interval, or may be related to a sum of values of the predetermined acoustic wave feature parameters of all the first audio sampling points in the corresponding allocation time interval.

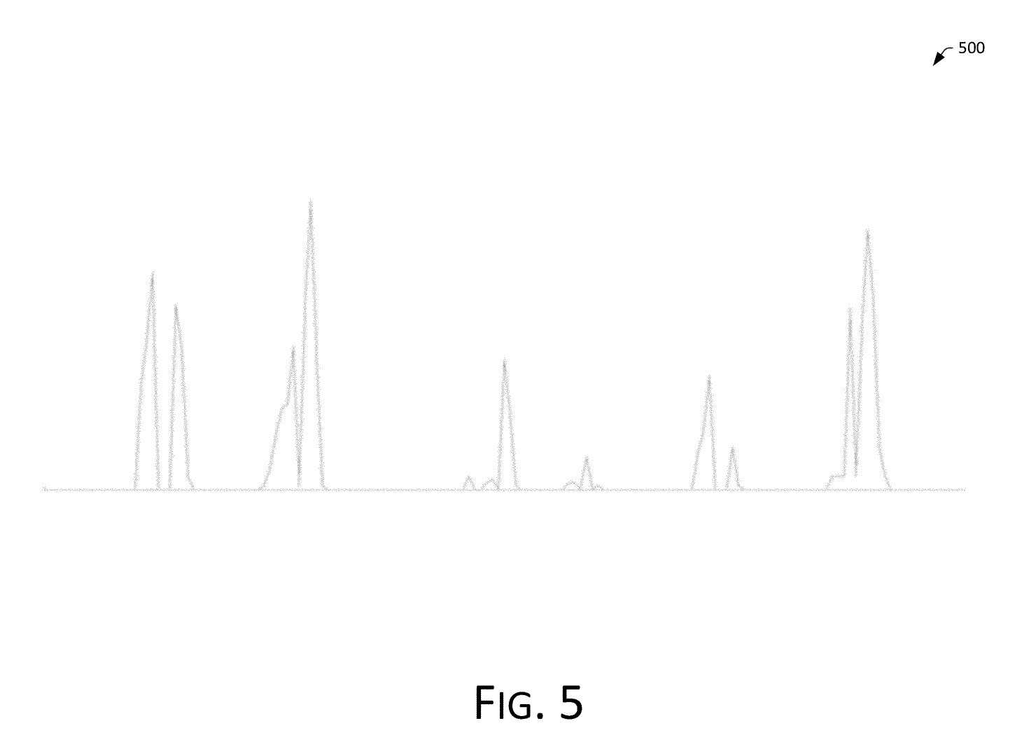

For example, a number of allocations may be positively related to the number of first audio sampling points in a corresponding allocation time interval or a sum of values of the predetermined acoustic feature parameters of all the first audio sampling points in the corresponding allocation time interval. For example, a predetermined acoustic feature parameter is assumed to be a “vibration amplitude”. An audio sampling point with the vibration amplitude being not less than a predetermined value may be treated as a first audio sampling point. The more the first audio sampling points are included in each lottery interval, the more the corresponding number of prizes is. Alternatively, values of vibration amplitudes of first audio sampling points in each lottery interval are respectively summed. The larger the sum of vibration amplitudes of all first audio sampling points in a lottery interval is, the larger the corresponding number of prizes is. Therefore, in a process of playing the lottery music, the number of prizes can be relatively small in a relatively slow-paced portion such as the main song as the emotion of users has not been mobilized, and so the probability that a user wins a prize under a same condition is correspondingly smaller. In a relatively fast-paced portion such as the chorus, the user's emotion become more excited by the rhythm of the music itself, and the number of prizes can be relatively more, so that the probability that a user wins a prize under the same condition is correspondingly larger. As such, the users' rising mood complements each other, giving the users a stronger sense of winning and helping to enhance their experience. For example, FIG. 5 shows a distribution map 500 of the number of prizes. By comparing FIG. 4 with FIG. 5, the distribution 500 of the number of prizes matches the waveform 400 of the lottery music.

Apparently, since a number of allocations is related to a number of first audio sampling points in a corresponding allocation time interval (or a sum of values of predetermined acoustic feature parameters of all the first audio sampling points in the corresponding allocation time interval), these two parties may not only have the above positive correlation relationship, but also other quantitative relationships such as a negative correlation. For example, the larger the number of first audio sampling points included in each lottery interval is, the smaller the corresponding number of prizes is. Alternatively, values of vibration amplitudes of first audio sampling points in each lottery interval are respectively summed. The larger the sum of vibration amplitudes of all first audio sampling points in a lottery interval is, the smaller the corresponding number of prizes is.

2. Object Allocation Stage 600

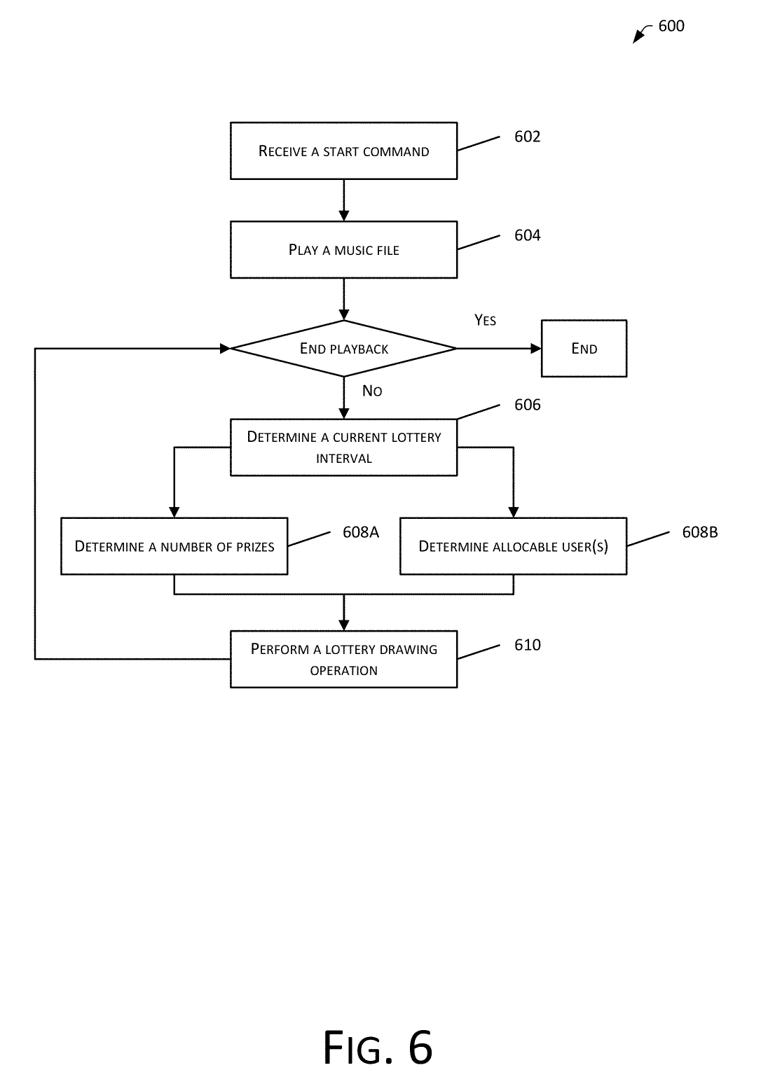

As shown in FIG. 6, the object allocation stage 600 can include the following operations.

Operation 602: Receive a start command.

In implementations, the start command is equivalent to the “allocation start command” in the embodiment shown in FIG. 1B. When multiple pieces of lottery music exist, a staff may need to initiate a start command for each piece of lottery music separately. Alternatively, the staff may only need to initiate a start command for a first piece of lottery music, and a subsequent piece of lottery music will be automatically played after an end of a previous piece of lottery music. The end of playing the previous piece of lottery music is equivalent to “initiating” the start command to a next piece of lottery music.

Operation 604: Play a music file.

In implementations, the music file is obtained from the above “pre-processing stage”. In a process of playing the music file, each lottery interval is viewed in turn, and corresponding lottery drawing and prize issuing operations are performed until the music file is stopped playing.

Operation 606: Determine a current lottery interval.

Operation 608A: Determine a number of prizes.

In implementations, the number of prizes is related to the current lottery interval, and the number of prizes corresponding to each lottery interval is determined by the foregoing “pre-processing stage”, and details thereof are not repeatedly described herein.

Operation 608B: Determine allocable user(s).

As an exemplary embodiment, the server may receive allocation request(s) sent by user(s) through electronic device(s). When an allocation request from any user is received within any one of the allocation time intervals, the any user is taken as an allocable user corresponding to the any one of the allocation time intervals.

For example, allocation requests sent by a user A and a user B are assumed to be received in the current lottery interval respectively. In this case, the user A and the user B are regarded as allocable users, i.e., the user A and the user B can participate in a prize issuing activity corresponding to the current lottery interval. Since an allocation request sent by a user C is not received in the current lottery interval, the user C cannot participate in a lottery drawing activity of the current lottery interval.

As another exemplary embodiment, the server may determine a group to which an arbitrary user belongs when an allocation request is received from the arbitrary user. When the group is a predefined association group corresponding to any one of the allocation time intervals, the arbitrary user is set as an allocable user corresponding to the any one of the allocation time intervals. In other words, if a predefined association group corresponding to each allocation time interval is pre-configured, only members of the predefined association group can be allocable users of the respective allocation time interval, and other users cannot participate in object allocation within that allocation time interval, i.e., lottery drawing activities, etc.

For example, the pre-defined association groups corresponding to the current lottery interval are assumed to include an enterprise AA and a group BB. When the server receives allocation requests of a user D, a user E, and a user F respectively, only the user D and the user E can be regarded as allocable users and participate in a lottery drawing event, and the user F cannot become an allocable user and cannot participate in the lottery drawing event, if the user D belongs to the enterprise AA, the user E belongs to the group BB, and the user F belong to an enterprise CC.

In the above embodiments, an allocable user may have multiple forms of request initiation when initiating an allocation request through an electronic device. For example, the allocable user can shake the electronic device, and the electronic device can initiate an allocation request to the server when detecting the user's shaking operation. Alternatively, the allocable user can continuously click a button displayed on a touch screen of the electronic device, and the electronic device may then initiate an allocation request to the server when detecting each click or multiple consecutive clicks of the user. Alternatively, the electronic device may also detect a predetermined operation performed by the user through other manners, thereby initiating a corresponding allocation request to the server.

Operation 610: Perform a lottery drawing operation.

In implementations, when performing a lottery drawing operation, the server may give out all the prizes in the current lottery interval according to a winning probability corresponding to each allocable user.

In an exemplary embodiment, each allocable user has a same winning probability, i.e., all prizes are equally distributed to all allocable users.

In another exemplary embodiment, the server may count the number of allocation requests sent by each allocable user within a respective allocation time interval, and a probability that each allocable user is allocated with an object is positively correlated with a corresponding counted value thereof. In other words, a allocable user can increase a probability that he/she can be allocated with an object by sending more allocation requests within each allocation time interval. Therefore, an allocable user can continuously initiate a lottery drawing request (equivalent to an allocation request) to the server within a current lottery interval, so as to have a higher probability of receiving a prize.

In another exemplary embodiment, the server may allocate objects corresponding to any one of the allocation time intervals to corresponding allocable users according to a predefined allocation probability corresponding to each predefined association group corresponding to the any one of the allocation time intervals. In other words, a probability that an allocable user can be assigned with an object is related to a group to which he/she belongs. Therefore, if activities such as promotion or marketing are needed to target at some groups, predefined allocation probabilities corresponding to these groups can be increased, so that members thereof can be allocated with the objects more easily.

It should be noted:

1) When a predetermined audio file corresponds to a plurality of allocation time intervals, a processing method corresponding to each of the allocation time intervals may be the same or may be independent of each other. For example, for the method of determining an allocable user at operation 608B, a user corresponding to a received allocation request may be added as an allocable user in a portion of the allocation time intervals, and a sender of an allocation request received in another portion of the allocation time intervals is added as an allocable user only when he/she belongs to a corresponding predefined association group.

Similarly, for the lottery drawing operation at operation 610, a strategy in which all allocable users have the same allocation probability may be adopted in a portion of the allocation time intervals, and in another portion of the allocation time intervals, a strategy in which the allocation probability is positively related to the number of allocation requests may be adopted. A strategy according to a predefined allocation probability corresponding to a predefined association group may be adopted in still another portion of the allocation time intervals, for example.

2) When a prize is a virtual item, the server can directly distribute the virtual item to a corresponding user through mail, SMS, etc. When the prize is a physical item, the server can use ID information or the like of the physical item to participate in the lottery drawing activity. After a user who wins the prize is determined, the physical item is distributed to the user through physical distribution or the like. Alternatively, the user goes to a designated place to collect the corresponding physical item after the user is informed of the ID information.

3) Each user can be configured with a corresponding maximum number of allocations, for example, each user can only be allocated with at most 2 objects. As such, when a user A has been allocated with 2 objects, the user A is excluded from being an “allocable user” even if the user A satisfies a selection rule for the “allocable user”.

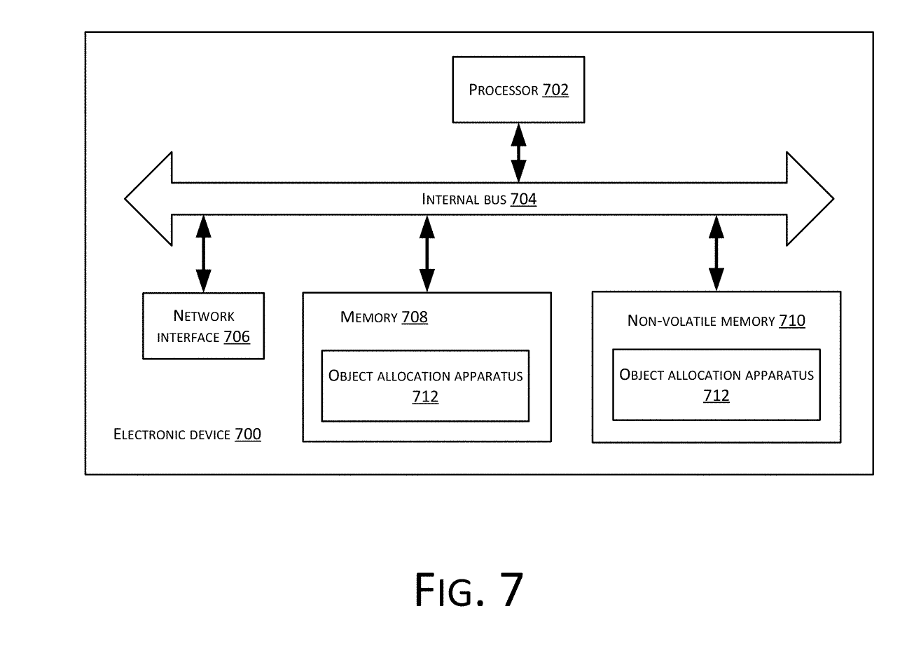

FIG. 7 shows a schematic structural diagram of an electronic device according to an exemplary embodiment of the present disclosure. Referring to FIG. 7, at the hardware level, the electronic device includes a processor 702, an internal bus 704, a network interface 706, memory 708, and non-volatile memory 710, and apparently may also include hardware components that are needed for other services. The processor 702 reads a corresponding computer program from the non-volatile memory 710 into the memory 708, and then runs, forming an object allocation apparatus 712 on a logical level. Apparently, in addition to software implementations, the present disclosure does not exclude other ways of implementation, such as in a form of logic device(s) or a combination of software and hardware, etc. In other words, an execution body of the following flow of processing is not limited to each logical unit, and may be hardware or logic device(s).

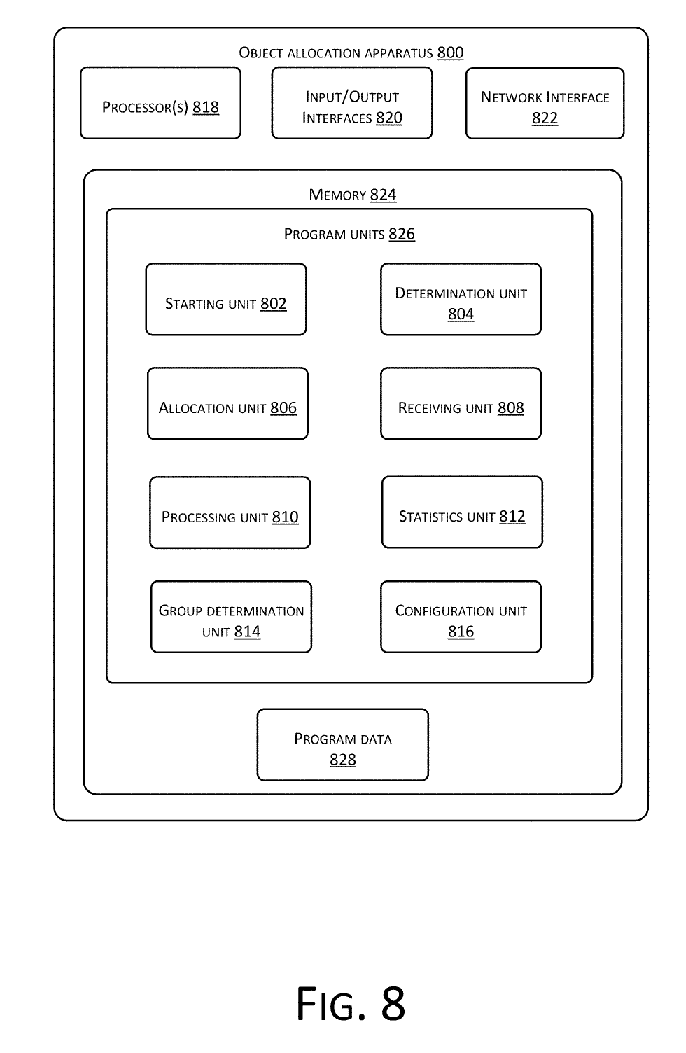

Referring to FIG. 8, in implementations, an object allocation apparatus 800 may include a starting unit 802, a determination unit 804, and an allocation unit 806.

The starting unit 802 is configured to start a playback of a predetermined audio file according to a received allocation start command.

The determination unit 804 is configured to determine allocation time intervals corresponding to the predetermined audio file, and a number of allocations corresponding to each allocation time interval, wherein the number of allocations is related to a predetermined acoustic feature parameter of the predetermined audio file in the respective allocation time interval.

The allocation unit 806 is configured to obtain and allocate the number of allocations of objects to allocable users corresponding to the respective allocation time interval.

In implementations, the allocation time intervals are a plurality of intervals obtained by dividing a playback sequence of the predetermined audio file according to a predetermined duration.

In implementations, the predetermined audio file has a plurality of audio sampling points in each allocation time interval. The number of allocations is related to the number of the first audio sampling points or a sum of values of acoustic feature parameters of all the first audio sampling points in the respective allocation time interval. The values of the predetermined acoustic feature parameters of the first audio sampling points satisfy a predetermined numerical criterion.

In implementations, the number of allocations is positively related to the number of the first audio sampling points or the sum of the values of the acoustic feature parameters of all the first audio sampling points in the respective allocation time interval.

In implementations, the predetermined numerical criterion includes being not less than a predetermined value.

In implementations, the predetermined acoustic wave feature parameter includes at least one of the following: a vibration frequency and a vibration amplitude.

In implementations, the apparatus 800 may further include a receiving unit 808 configured to receive an allocation request sent by a user through an electronic device; and a processing unit 810 configured to set an arbitrary user as an allocable user corresponding to any one of the allocation time intervals when receiving an allocation request from the arbitrary user within the any one of the allocation time intervals.

In implementations, the apparatus 800 may further include a statistics unit 812 configured to count the number of allocation requests sent by each allocable user in a corresponding allocation time interval, wherein a probability that each allocable user is allocated with an object is positively correlated with a corresponding counted value thereof.

In implementations, the apparatus 800 may further include a group determination unit 814 configured to determine a group to which an arbitrary user belongs when receiving an allocation request from the arbitrary user; and a configuration unit 816 configured to set the arbitrary user as an allocable user corresponding to any one of the allocation time intervals when the group is a predefined association group corresponding to the any one of the allocation time intervals.

In implementations, the allocation unit 806 may be further configured to allocate objects corresponding to any one of the allocation time intervals to corresponding allocable users according to a respective predefined allocation probability corresponding to each predefined association group.

In implementations, the apparatus 800 may further include one or more processors 818, an input/output (I/O) interface 820, a network interface 822, and memory 824.

The memory 824 may include a form of computer readable media such as a volatile memory, a random access memory (RAM) and/or a non-volatile memory, for example, a read-only memory (ROM) or a flash RAM. The memory 824 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 824 may include program units 826 and program data 828. The program units 826 may include one or more of the modules as described in the foregoing description and shown in FIG. 8.

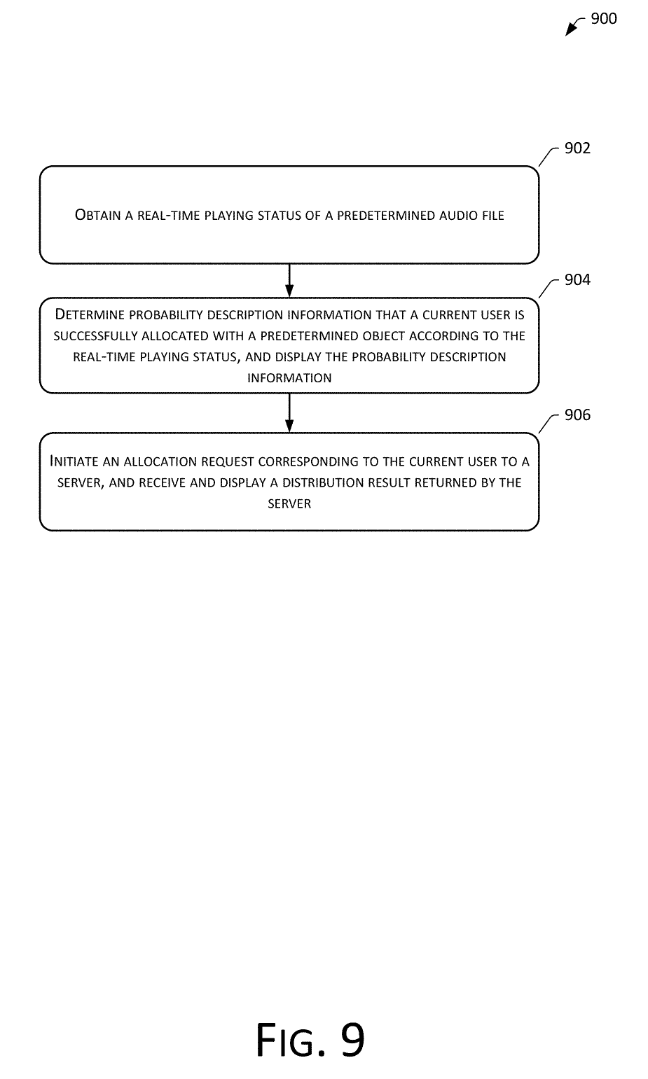

Corresponding to the server-side object allocation solutions shown in FIG. 1B, FIG. 3 and FIG. 6, the present disclosure also describes an object allocation solution based on the present disclosure from a client perspective. FIG. 9 is a flowchart of a client-side object allocation method 900 according to an exemplary embodiment of the present disclosure. As shown in FIG. 9, the method 900 is applied to an electronic device, and may include the following operations.

Operation 902: Obtain a real-time playing status of a predetermined audio file.

Operation 904: Determine probability description information that a current user is successfully allocated with a predetermined object according to the real-time playing status, and display the probability description information.

Operation 906: Initiate an allocation request corresponding to the current user to a server, and receive and display a distribution result returned by the server.

In the above embodiment, by displaying probability description information on an electronic device, a user can view and understand a winning probability (i.e., a probability of being successfully allocated with a predetermined object) at any time, thereby being able to enhance interactivity and interestingness, stimulate user engagement, and help to improve the user experience when participating in a lottery activity of a server (i.e., object allocation operations).

In the above embodiment, probability description information such as the one described at operation 904 can be determined in various ways, and the process is exemplified hereinafter.

### First Embodiment

As an exemplary embodiment, at operation 902, an electronic device may receive a real-time playback progress of a predetermined audio file sent by a server as a real-time playing status described above. Furthermore, at operation 904, by obtaining a predefined allocation rule corresponding to the audio file (the predefined allocation rule includes predefined allocation time intervals corresponding to the predetermined audio file and an allocation probability corresponding to each time interval), the electronic device may determine a predefined allocation time interval corresponding to the real-time playback progress accordingly, and display a corresponding allocation probability as the probability description information as described above.

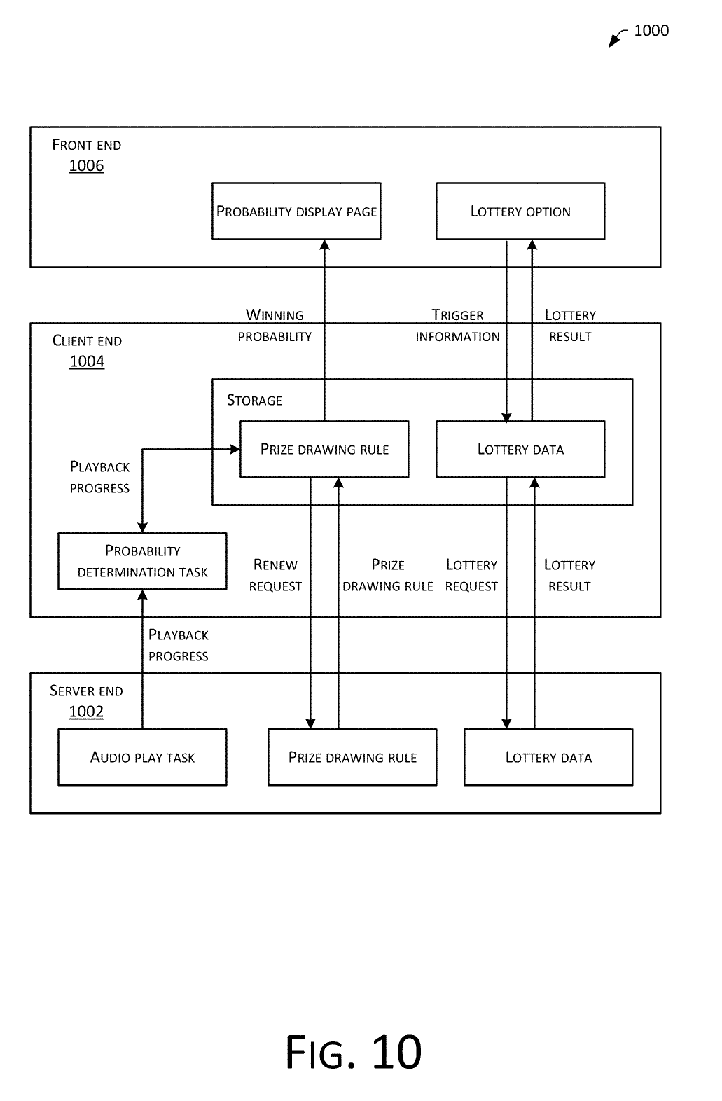

For example, FIG. 10 is a diagram of a system architecture 1000 that implements an object allocation function according to an exemplary embodiment of the present disclosure. In implementations, a “sweepstake” scenario is taken as an example to describe the object allocation solutions of the present disclosure. As shown in FIG. 10, the system architecture 1000 may include three parts—a server end 1002, a client end 1004, and a front end 1006. The server end 1002 may be hosted by a server, and the client end 1004 and the front end 1006 are manifested as an application program installed in an electronic device of a user. The application program can be used to implement the object allocation solutions of the present disclosure. It should be noted that, in one circumstance, an installation of the client end 1004 and the front end 1006 can be completed at the same time when the user installs the application program. As such, when the user starts the application program, a probability display page can be presented, and lottery options can be displayed on the page, by using local data that is configured on the electronic device at the time of installation only. In another circumstance, when the user installs the application program, only the client end 1004 can be installed. In this case, when the user launches the application program, relevant page data can be downloaded, and a probability display page and lottery options, etc., can be presented. For example, the probability display page and the lottery options can be implemented using HTML5 technology. Apparently, regardless of which approach is used, the technical solutions of the present disclosure can be implemented by using necessary data interactions between the front end 1006 and the client end 1004, which is not limited by the present disclosure.

As shown in FIG. 10, an “audio play task” is configured on the server end 1002, and the “audio play task” can obtain a real-time play progress of a predetermined audio file played in a lottery operation, and provide the progress to the client end 1004. The server end 1002 is also configured with a “prize drawing rule”. The “prize drawing rule” includes a predefined allocation rule, such as predefined allocation time intervals corresponding to a predetermined audio file and an allocation probability corresponding to each time interval (which is equivalent to a winning probability). Correspondingly, the client end 1004 is configured with a “prize drawing rule” and a “probability determination task”. The “prize drawing rule” is consistent with the “prize drawing rule” on the server end 1002, and the “probability determination task” can respectively obtain the real-time playback progress and the predefined allocation rule in the “prize drawing rule” of the client end 1004 provided by the “audio play task” of the server end 1002, thereby determining a real-time winning probability for displaying in the “probability display page” of the front end 1006 accordingly. At the same time, the front end 1006 can also show the “lottery options”, so that the user can click a displayed lottery option to cause the client end 1004 to obtain corresponding trigger information, and initiate a corresponding lottery request (equivalent to an allocation request) to the server end through “lottery data”. A corresponding lottery result is then returned by the server end 1002, and displayed at the front end 1006.

In an exemplary scenario, the server end 1002 may provide a playback of the predetermined audio file to the user in a form of a television playback, a broadcast playback, or a live playback. At the same time, the user may perform a lottery operation through the electronic device such as a mobile phone. The server can then provide the real-time playing progress of the predetermined audio file through data interactions with the electronic device. The electronic device can determine and display a corresponding winning probability according to the real-time playing progress and the predefined allocation rule. Moreover, the user may click a lottery option displayed on the electronic device, and apparently, may also initiate a lottery request to the server end 1002 through an operation such as “shaking” of the electronic device. After the server end 1002 performs the lottery operation, the electronic device receives and displays a corresponding lottery result.

### Second Embodiment

As an exemplary embodiment, at operation 902, the electronic device may obtain a predetermined acoustic feature parameter of the predetermined audio file in real time as the real-time playing status. At operation 904, the electronic device may generate and display probability description information expressing a high allocation probability when a value of the predetermined acoustic feature parameter satisfies a predetermined numerical criterion, and generate and display probability description information expressing a low allocation probability when the value of the predetermined acoustic feature parameter does not satisfy the predetermined numerical criterion.

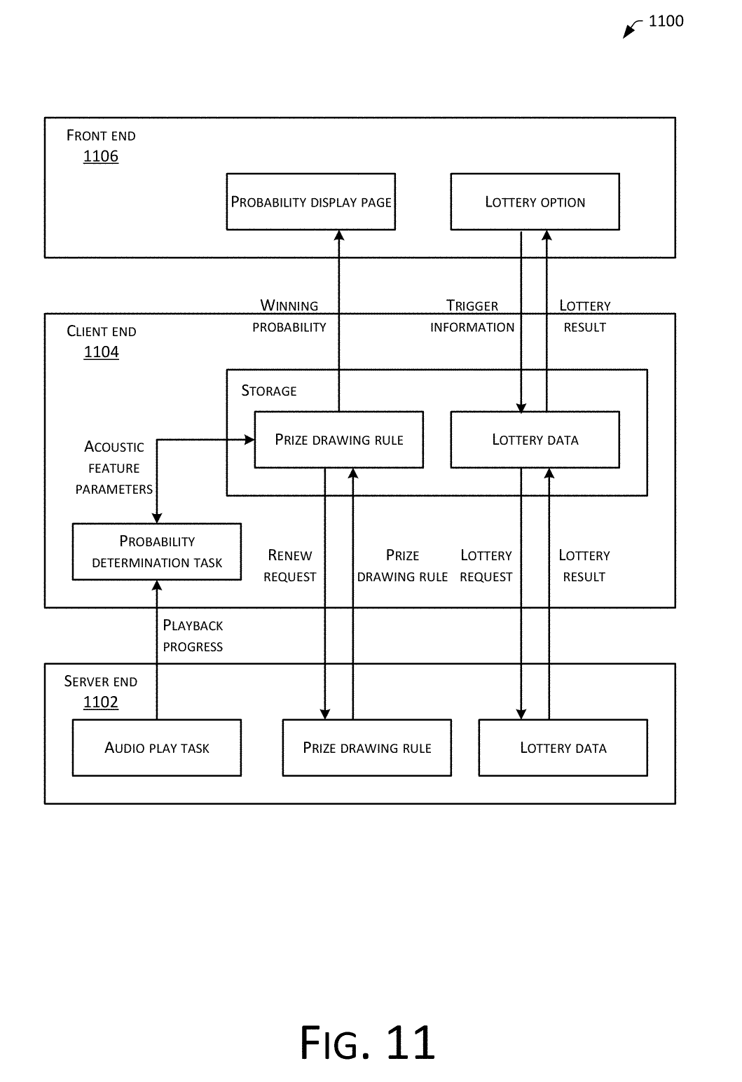

For example, FIG. 11 is a diagram of another system architecture 1100 that implements an object allocation function according to an exemplary embodiment of the present disclosure. As shown in FIG. 11, the system architecture 1100 may include a server end 1102, a client end 1104, and a front end 1106. A relationship among these three parties can be referenced to the above description and FIG. 10, and is not repeatedly described herein. An “audio play task” is configured on the server end 1102. The “audio play task” can play a predetermined audio file during a lottery operation. The server end 1102 is also configured with a “prize drawing rule”. The “prize drawing rule” includes a predefined allocation rule, such as predefined allocation time intervals corresponding to the predetermined audio file and an allocation probability corresponding to each time interval (which is equivalent to a winning probability). Correspondingly, the client end has a “prize drawing rule” and an “audio collection task”. The “prize drawing rule” is consistent with the “prize drawing rule” on the server end. The “audio collection task” can invoke a microphone, etc., on an electronic device to which the client end belongs, to collect the predetermined audio file played by the server end 1102, and determine a real-time winning probability for displaying in a “probability display page” at the front end 1106 based on the predefined allocation rule provided by the “prize drawing rule” provided by the client end 1104. At the same time, the front end 1106 can also show “lottery options”, so that a user can click a displayed lottery option to cause the client end 1104 to obtain corresponding trigger information, and initiate a corresponding lottery request (which is equivalent to an allocation request) to the server end 1102 through “lottery data”. A corresponding lottery result is then returned by the server end 1102, and displayed at the front end 1106.

In an exemplary scenario, the server end 1102 may provide a playback of the predetermined audio file to the user in a form of a television playback, a broadcast playback, or a live playback. At the same time, the user may perform a lottery operation through the electronic device such as a mobile phone. The playing sound of the predetermined audio file can then be collected through a device component such as a microphone on the electronic device, and a corresponding winning probability is thereby determined and displayed according to the predefined allocation rule. For example, when a relatively flat playback interval of the audio file is identified, a lower winning probability can be used. A higher winning probability can be used when the audio file is in a relatively high-spirited playback interval. Moreover, the user may click a lottery option displayed on the electronic device, and apparently, may initiate a lottery request to the server end 1102 through an operation such as “shaking” of the electronic device. After the server end 1102 performs the lottery operation, the electronic device receives and presents a corresponding lottery result.

It should be noted that in FIG. 10-11, the “probability display page” in the front end represents data and functions used for realizing the probability display page, and the “lottery option” represents data and functions used for realizing a lottery option in the probability display page. Similarly, “storage” in the client end represents a function used for implementing storage, and the “prize drawing rule” represents a function used for realizing a lottery rule and data of the lottery rule. The “sweepstake data” represents a function used for processing the lottery data and the lottery data such as the trigger information and the lottery result itself, etc., which are not exhaustively described herein.

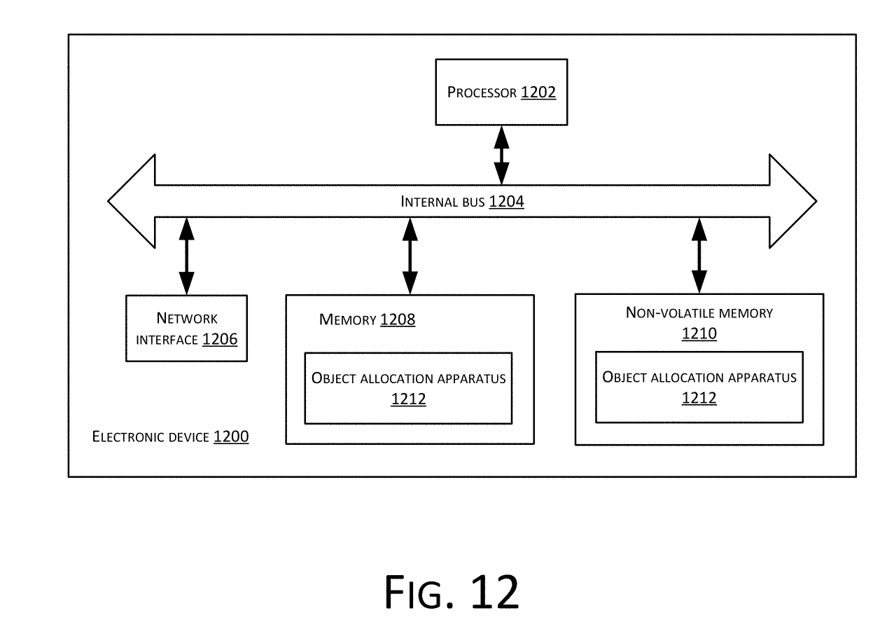

FIG. 12 shows a schematic structural diagram of an electronic device 1200 according to an exemplary embodiment of the present disclosure. Referring to FIG. 12, at the hardware level, the electronic device includes a processor 1202, an internal bus 1204, a network interface 1206, memory 1208, and non-volatile memory 1210, and apparently may also include hardware components needed by other services. The processor 1202 reads a corresponding computer program from the non-volatile memory 1210 into the memory and then runs, forming an object allocation apparatus on a logical level. Apparently, in addition to software implementations, the present disclosure does not exclude other implementation manners, such as a form of logic device(s) or a combination of software and hardware, etc. In other words, an execution entity of the following flow of processing is not limited to each logical unit, and may be hardware or logic device(s).

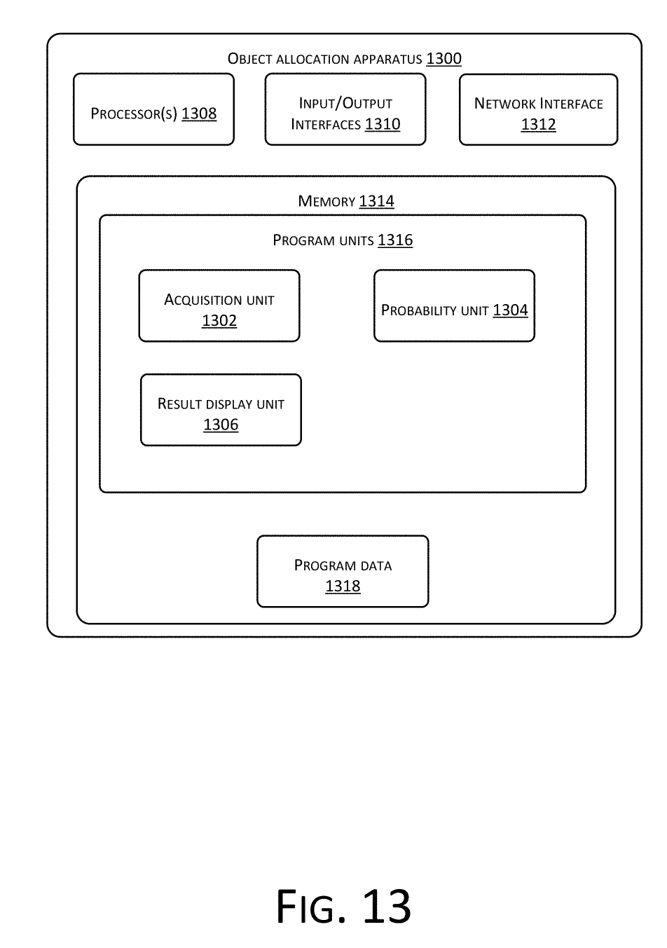

FIG. 13 is a structural diagram of an object allocation apparatus 1300 in accordance with an exemplary embodiment of the present disclosure. In implementations, the object allocation apparatus 1300 may include one or more computing devices. In implementations, the object allocation apparatus 1300 may be a part of one or more computing devices, e.g., implemented or run by the one or more computing devices. In implementations, the one or more computing devices may be located in a single place or distributed among a plurality of network devices over a network. Referring to FIG. 13, in implementations, the object allocation apparatus 1300 may include an acquisition unit 1302, a probability display unit 1304, and a result display unit 1306.

The acquisition unit 1302 is configured to obtain a real-time playing status of a predetermined audio file.

The probability display unit 1304 determines probability description information that a current user is successfully allocated with a predetermined object based on the real-time playing status, and displays the probability description information.

The result display unit 1306 initiates an allocation request corresponding to the current user to the server, and receives and displays an allocation result returned by the server.

In implementations, the acquisition unit 1302 may be further configured to receive a real-time playing progress of the predetermined audio file sent by the server.

The probability display unit 1304 may be further configured to obtain a predefined allocation rule corresponding to the predetermined audio file, wherein the predefined allocation rule includes predefined allocation time intervals corresponding to the predetermined audio file and an allocation probability corresponding to each time interval; and determine a predefined allocation time interval corresponding to the real-time playing progress, and display a corresponding allocation probability as the probability description information.

In implementations, the acquisition unit 1302 may be further configured to collect a predetermined acoustic feature parameter of the predetermined audio file in real time.

The probability display unit 1304 may be further configured to generate and display probability description information indicating a high allocation probability when a value of the predetermined acoustic feature parameter satisfies a predetermined numerical criterion; and generate and display probability description information indicating a low allocation probability when the value of the predetermined acoustic feature parameter does not satisfy the predetermined numerical criterion.

In implementations, the apparatus 1300 may further include one or more processors 1308, an input/output (I/O) interface 1310, a network interface 1312, and memory 1314. The memory 1314 may include a form of computer readable media as described in the foregoing description.

In implementations, the memory 1314 may include program units 1316 and program data 1318. The program units 1316 may include one or more of the modules as described in the foregoing description and shown in FIG. 13.

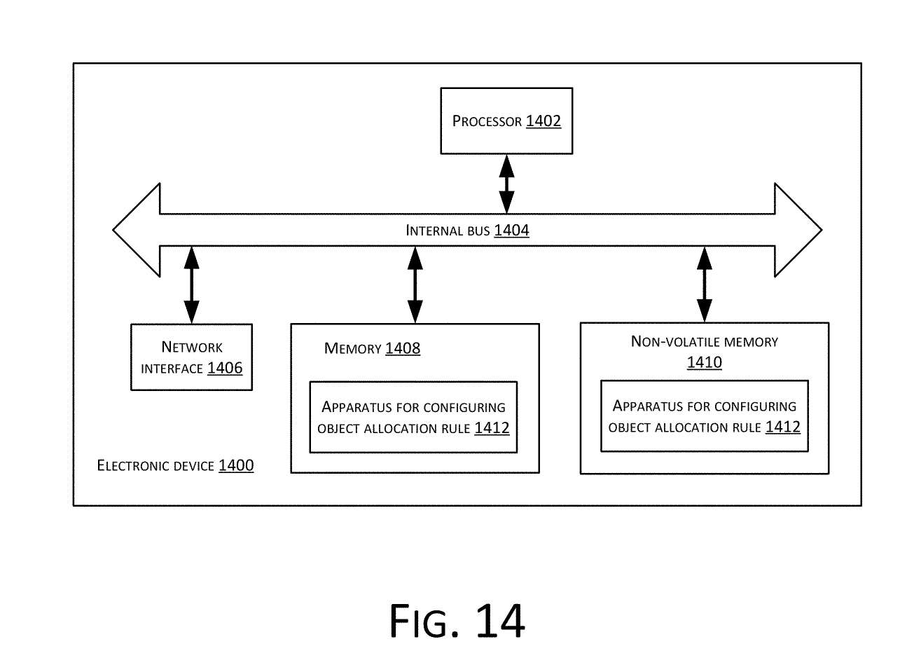

FIG. 14 shows a schematic structural diagram of an electronic device 1400 according to an exemplary embodiment of the present disclosure. Referring to FIG. 14, at the hardware level, the electronic device includes a processor 1402, an internal bus 1404, a network interface 1406, memory 1408, and non-volatile memory 1410, and apparently may also include hardware components needed by other services. The processor 1402 reads a corresponding computer program from the non-volatile memory 1410 into the memory 1408 and then runs, forming an apparatus for configuring an object allocation rule on a logical level. Apparently, in addition to software implementations, the present disclosure does not exclude other implementation manners, such as a form of logic device(s) or a combination of software and hardware, etc. In other words, an execution entity of the following flow of processing is not limited to each logical unit, and may be hardware or logic device(s).

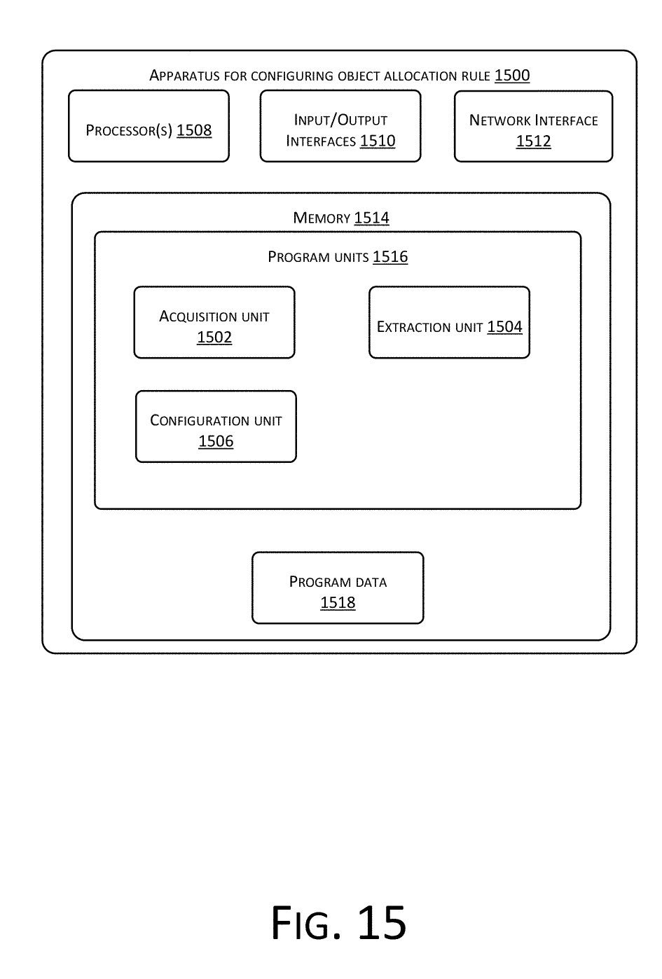

FIG. 1500 is a structural diagram of an apparatus for configuring an object allocation rule 1500 in accordance with an exemplary embodiment of the present disclosure. In implementations, the apparatus 1500 may include one or more computing devices. In implementations, the apparatus 1500 may be a part of one or more computing devices, e.g., implemented or run by the one or more computing devices. In implementations, the one or more computing devices may be located in a single place or distributed among a plurality of network devices over a network. Referring to FIG. 15, in implementations, the 1500 may include an acquisition unit 1502, an extraction unit 1504, and a configuration unit 1506.

The acquisition unit 1502 is configured to obtain a predetermined audio file for object allocation.

The extraction unit 1504 is configured to separately extract predetermined acoustic feature parameters of the predetermined audio file in each allocation time interval according to allocation time intervals corresponding to the predetermined audio file.

The configuration unit 1506 is configured to set a respective number of allocations corresponding to each allocation time interval according to the predetermined acoustic feature parameters, wherein a corresponding number of allocations of objects are allocated to allocable users corresponding to an arbitrary one of the allocation time intervals when the predetermined audio file is played in the arbitrary one of the allocation time intervals.

In implementations, the configuration unit 1506 may be further configured to determine a plurality of audio sampling points in each allocation time interval from the predetermined audio file, wherein values of predetermined acoustic characteristic parameters of the first audio sampling points satisfy a predetermined numerical criterion; and set the respective number of allocations based on a number of the first audio sampling points or a sum of the values of the predetermined acoustic characteristic parameters of all the first audio sampling points in each allocation time interval.

In implementations, the respective number of allocations is positively related to the number of the first audio sampling points or the sum of the values of the predetermined acoustic characteristic parameters of all the first audio sampling points in the respective allocation time interval.

In implementations, the predetermined numerical criterion includes being not less than a predetermined value.

In implementations, the allocation time intervals are a plurality of intervals obtained by dividing a playback sequence of the predetermined audio file according to a predetermined time length.

In implementations, the predetermined acoustic feature parameter includes at least one of the following: a vibration frequency and a vibration amplitude.

In implementations, the apparatus 1500 may further include one or more processors 1508, an input/output (I/O) interface 1510, a network interface 1512, and memory 1514. The memory 1514 may include a form of computer readable media as described in the foregoing description.

In implementations, the memory 1514 may include program units 1516 and program data 1518. The program units 1516 may include one or more of the modules as described in the foregoing description and shown in FIG. 15.

In a typical configuration, a computing device includes one or more processors (CPU), an input/output interface, a network interface, and memory.

The memory may include a form of computer readable media such as a volatile memory, a random access memory (RAM) and/or a non-volatile memory, for example, a read-only memory (ROM) or a flash RAM. The memory is an example of a computer readable media. The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

It also needs to be noted that terms “include”, “contain” or any other variations thereof are intended to cover a non-exclusive inclusion, such that a process, method, article, or device that includes a series of elements includes not only these elements, but also includes other elements that are not explicitly listed, or also includes elements that are inherent in such process, method, article, or device. Without any further limitation, an element defined by a statement “including a . . . ” does not exclude a process, method, article, or device including the element from further including another identical element.

The above description is only the preferred embodiments of the present disclosure, and is not intended to limit the present disclosure. Any modifications, equivalent replacements, improvements, etc., which are made within the spirit and principles of the present disclosure, should be included in the scope of protection of the present disclosure.

Clause 1: An object allocation method comprising: starting a playback of a predetermined audio file according to a received allocation start command; determining allocation time intervals corresponding to the predetermined audio file, and a number of allocations corresponding to each allocation time interval, wherein the number of allocations is related to a predetermined acoustic feature parameter of the predetermined audio file in the respective allocation time interval; and obtaining and allocating the number of allocations of objects to allocable users corresponding to the respective allocation time interval.

Clause 2: The method of Clause 1, further comprising: determining a group to which any one user belongs in response to receiving an allocation request from the any one user; and setting the any one user as an allocable user corresponding to any one of the allocation time intervals when the group is a predefined association group corresponding to the any one of the allocation time intervals.

Clause 3: The method of Clause 2, wherein obtaining and allocating the number of allocations of the objects to the allocable users corresponding to the respective allocation time interval comprises allocating objects corresponding to the any one of the allocation time intervals to corresponding allocable users according to a predefined allocation probability corresponding to each predefined association group.

Clause 4: The method of Clause 1, further comprising: receiving allocation requests sent by users through electronic devices; and setting any one of the users as an allocable user corresponding to any one of the allocation time intervals in response to receiving an allocation request of the any one of the users in the any one of the allocation time intervals.

Clause 5: The method of Clause 4, further comprising: counting a number of allocation requests sent by each allocable user in a corresponding allocation time interval, wherein a probability that each allocable user is allocated with an object is positively related to a corresponding counted value thereof.

Clause 6: An object allocation apparatus comprising: a starting unit configured to start a playback of a predetermined audio file according to a received allocation start command; a determination unit configured to determine allocation time intervals corresponding to the predetermined audio file, and a number of allocations corresponding to each allocation time interval, wherein the number of allocations is related to a predetermined acoustic feature parameter of the predetermined audio file in the respective allocation time interval; and an allocation unit configured to obtain and allocate the number of allocations of objects to allocable users corresponding to the respective allocation time interval.

Clause 7: The apparatus of Clause 6, further comprising: a group determination unit configured to determine a group to which any one user belongs in response to receiving an allocation request from the any one user; and a configuration unit configured to set the any one user as an allocable user corresponding to any one of the allocation time intervals when the group is a predefined association group corresponding to the any one of the allocation time intervals.

Clause 8: The apparatus of Clause 7, wherein the allocation unit is specifically configured to allocate objects corresponding to the any one of the allocation time intervals to corresponding allocable users according to a predefined allocation probability corresponding to each predefined association group.

Clause 9: The apparatus of Clause 6, further comprising: a receiving unit configured to receive allocation requests sent by users through electronic devices; and a processing unit configured to set any one of the users as an allocable user corresponding to any one of the allocation time intervals in response to receiving an allocation request of the any one of the users in the any one of the allocation time intervals.

Clause 10: The apparatus of Clause 9, further comprising: a statistics unit configured to count a number of allocation requests sent by each allocable user in a corresponding allocation time interval, wherein a probability that each allocable user is allocated with an object is positively related to a corresponding counted value thereof.

Clause 11: An object allocation method comprising: obtaining a real-time playback status of a predetermined audio file; determining probability description information of a current user being successfully allocated with a predetermined object according to the real-time playing status, and displaying the probability description information; and initiating an allocation request corresponding to the current user to a server, and receiving and displaying an allocation result returned by the server.

Clause 12: The method of Clause 11, wherein: obtaining the real-time playback status of the predetermined audio file comprises receiving a real-time playback progress of the predetermined audio file sent by the server; and determining the probability description information of the current user being successfully allocated with the predetermined object according to the real-time playing status, and displaying the probability description information comprise: obtaining a predefined allocation rule corresponding to the predetermined audio file, the predefined allocation rule comprising predefined allocation time intervals corresponding to the predetermined audio file and an allocation probability corresponding to each time interval; and determining a predefined allocation time interval corresponding to the real-time playback progress, and displaying a corresponding allocation probability as the probability description information.

Clause 13: The method of Clause 11, further comprising: obtaining the real-time playback status of the predetermined audio file comprises collecting a predetermined acoustic feature parameter of the predetermined audio file in real time; and determining the probability description information of the current user being successfully allocated with the predetermined object according to the real-time playing status, and displaying the probability description information comprise: generating and displaying probability description information indicating a high allocation probability when a value of the predetermined acoustic feature parameter satisfies a predetermined numerical criterion; and generating and displaying probability description information indicating a low allocation probability when the value of the predetermined acoustic feature parameter does not satisfy the predetermined numerical criterion.

Clause 14: An object allocation apparatus comprising: an acquisition unit configured to obtain a real-time playback status of a predetermined audio file; a probability display unit configured to determine probability description information of a current user being successfully allocated with a predetermined object according to the real-time playing status, and display the probability description information; and a result display unit configured to initiate an allocation request corresponding to the current user to a server, and receive and display an allocation result returned by the server.

Clause 15: The apparatus of Clause 14, wherein: the acquisition unit is specifically configured to receive a real-time playing progress of the predetermined audio file sent by the server; and the probability display unit is specifically configured to: obtain a predefined allocation rule corresponding to the predetermined audio file, wherein the predefined allocation rule includes predefined allocation time intervals corresponding to the predetermined audio file and an allocation probability corresponding to each time interval; and determine a predefined allocation time interval corresponding to the real-time playing progress, and display a corresponding allocation probability as the probability description information.

Clause 16: The apparatus of Clause 14, wherein: the acquisition unit is specifically configured to collect a predetermined acoustic feature parameter of the predetermined audio file in real time; and the probability display unit is specifically configured to: generate and display probability description information indicating a high allocation probability when a value of the predetermined acoustic feature parameter satisfies a predetermined numerical criterion; and generate and display probability description information indicating a low allocation probability when the value of the predetermined acoustic feature parameter does not satisfy the predetermined numerical criterion.

Clause 17: A configuration method for an object allocation rule comprising: obtaining a predetermined audio file for object allocation; separately extracting predetermined acoustic feature parameters of the predetermined audio file in each allocation time interval according to allocation time intervals corresponding to the predetermined audio file; and configuring a respective number of allocations corresponding to each allocation time interval according to the predetermined acoustic feature parameters, wherein a corresponding number of allocations of objects are allocated to allocable users corresponding to an arbitrary one of the allocation time intervals when the predetermined audio file is played in the arbitrary one of the allocation time intervals.

Clause 18: The method of Clause 17, wherein configuring the number of allocations corresponding to the respective allocation time interval according to the predetermined acoustic feature parameters comprises: determining a plurality of audio sampling points in each allocation time interval from the predetermined audio file, wherein values of predetermined acoustic characteristic parameters of the first audio sampling points satisfy a predetermined numerical criterion; and setting the respective number of allocations based on a number of the first audio sampling points or a sum of the values of the predetermined acoustic characteristic parameters of all the first audio sampling points in each allocation time interval.

Clause 19: The method of Clause 18, wherein the respective number of allocations is positively related to the number of the first audio sampling points or the sum of the values of the predetermined acoustic characteristic parameters of all the first audio sampling points in the respective allocation time interval.

Clause 20: The method of Clause 18, wherein the predetermined numerical criterion includes being not less than a predetermined value.

Clause 21.: The method of Clause 17, wherein the allocation time intervals are a plurality of intervals obtained by dividing a playback sequence of the predetermined audio file according to a predetermined time length.

Clause 22: The method of Clause 17, wherein the predetermined acoustic feature parameter includes at least one of the following: a vibration frequency and a vibration amplitude.

Clause 23: A configuration apparatus for an object allocation rule, comprising: an acquisition unit configured to obtain a predetermined audio file for object allocation; an extraction unit configured to separately extract predetermined acoustic feature parameters of the predetermined audio file in each allocation time interval according to allocation time intervals corresponding to the predetermined audio file; and a configuration unit configured to set a number of allocations corresponding to the respective allocation time interval according to the predetermined acoustic feature parameters, wherein a corresponding number of allocations of objects are allocated to allocable users corresponding to an arbitrary one of the allocation time intervals when the predetermined audio file is played in the arbitrary one of the allocation time intervals.

Clause 24: The apparatus of Clause 23, wherein the configuration unit is specifically configured to: determine a plurality of audio sampling points in each allocation time interval from the predetermined audio file, wherein values of predetermined acoustic characteristic parameters of the first audio sampling points satisfy a predetermined numerical criterion; and set the respective number of allocations based on a number of the first audio sampling points or a sum of the values of the predetermined acoustic characteristic parameters of all the first audio sampling points in each allocation time interval.

What is claimed is:

1. A method implemented by one or more computing devices, the method comprising:
starting a playback of a predetermined audio file according to a received allocation start command;
determining allocation time intervals corresponding to the predetermined audio file, and a number of allocations corresponding to each allocation time interval; and
obtaining the number of allocations of objects and allocating the objects to allocable users corresponding to the respective allocation time interval.

2. The method of claim 1, wherein the number of allocations is related to a predetermined acoustic feature parameter of the predetermined audio file in the respective allocation time interval.

3. The method of claim 2, wherein the predetermined acoustic feature parameter comprises one or more of a vibration frequency or a vibration amplitude.

4. The method of claim 1, further comprising:
determining a group to which a particular user belongs in response to receiving an allocation request from the particular user; and
setting the particular user as an allocable user corresponding to a particular one of the allocation time intervals when the group is a predefined association group corresponding to the particular one of the allocation time intervals.

5. The method of claim 1, wherein obtaining and allocating the number of allocations of the objects to the allocable users corresponding to the respective allocation time interval comprises allocating objects corresponding to a particular allocation time interval of the allocation time intervals to corresponding allocable users according to a predefined allocation probability corresponding to each predefined association group.

6. The method of claim 1, further comprising:
receiving allocation requests sent by users through electronic devices; and
setting a particular user of the users as an allocable user corresponding to a particular one of the allocation time intervals in response to receiving an allocation request of the particular user of the users in the particular one of the allocation time intervals.

7. The method of claim 6, further comprising counting a number of allocation requests sent by each allocable user in a corresponding allocation time interval, wherein a probability that each allocable user is allocated with an object is positively related to a corresponding counted value thereof.

8. An apparatus comprising:
one or more processors;
memory;
an acquisition unit stored in the memory and executable by the one or more processors to obtain a real-time playback status of a predetermined audio file;
a probability display unit stored in the memory and executable by the one or more processors to determine probability description information of a current user being successfully allocated with a predetermined object according to the real-time playing status, and display the probability description information; and
a result display unit stored in the memory and executable by the one or more processors to initiate an allocation request corresponding to the current user to a server, and receive and display an allocation result returned by the server.

9. The apparatus of claim 8, wherein the acquisition unit is further configured to receive a real-time playing progress of the predetermined audio file sent by the server.

10. The apparatus of claim 9, wherein the probability display unit is further configured to:
obtain a predefined allocation rule corresponding to the predetermined audio file, wherein the predefined allocation rule includes predefined allocation time intervals corresponding to the predetermined audio file and an allocation probability corresponding to each time interval; and
determine a predefined allocation time interval corresponding to the real-time playing progress, and display a corresponding allocation probability as the probability description information.

11. The apparatus of claim 8, wherein the acquisition unit is further configured to collect a predetermined acoustic feature parameter of the predetermined audio file in real time.

12. The apparatus of claim 11, wherein the probability display unit is further configured to:
generate and display probability description information indicating a high allocation probability when a value of the predetermined acoustic feature parameter satisfies a predetermined numerical criterion; and
generate and display probability description information indicating a low allocation probability when the value of the predetermined acoustic feature parameter does not satisfy the predetermined numerical criterion.

13. The apparatus of claim 11, wherein the predetermined acoustic feature parameter includes at least one of: a vibration frequency or a vibration amplitude.

14. One or more computer readable media storing executable instructions that, when executed by one or more processors, cause the one or more processors to perform acts comprising:
obtaining a predetermined audio file for object allocation;
separately extracting predetermined acoustic feature parameters of the predetermined audio file in each allocation time interval according to allocation time intervals corresponding to the predetermined audio file; and
configuring a respective number of allocations corresponding to each allocation time interval according to the predetermined acoustic feature parameters.

15. The one more computer readable media of claim 14, wherein a corresponding number of allocations of objects are allocated to allocable users corresponding to an arbitrary one of the allocation time intervals when the predetermined audio file is played in the arbitrary one of the allocation time intervals.

16. The one more computer readable media of claim 15, wherein configuring the number of allocations corresponding to the respective allocation time interval according to the predetermined acoustic feature parameters comprises:
determining a plurality of audio sampling points in each allocation time interval from the predetermined audio file, wherein values of predetermined acoustic characteristic parameters of the first audio sampling points satisfy a predetermined numerical criterion; and
setting the respective number of allocations based on a number of the first audio sampling points or a sum of the values of the predetermined acoustic characteristic parameters of all the first audio sampling points in each allocation time interval.

17. The one more computer readable media of claim 16, wherein the respective number of allocations is positively related to the number of the first audio sampling points or the sum of the values of the predetermined acoustic characteristic parameters of all the first audio sampling points in the respective allocation time interval.

18. The one more computer readable media of claim 16, wherein the predetermined numerical criterion includes being not less than a predetermined value.

19. The one more computer readable media of claim 14, wherein the allocation time intervals are a plurality of intervals obtained by dividing a playback sequence of the predetermined audio file according to a predetermined time length.

20. The one more computer readable media of claim 17, wherein a predetermined acoustic feature parameter of the predetermined acoustic feature parameters comprises at least one of: a vibration frequency or a vibration amplitude.
